(19) United States
(12) Patent Application Publication
(10) Pub. No.: US 2010/0146713 A1
(43) Pub. Date: Jun. 17, 2010

(54) Method and Apparatus for Washing Fabrics Using Focused Ultrasound

(76) Inventors: Yoav Medan, Haifa (IL); Kobi Vortman, Haifa (IL); Shuki Vitek, Haifa (IL)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/621,710

(22) Filed: Nov. 19, 2009

Related U.S. Application Data
(60) Provisional application No. 61/116,832, filed on Nov. 21, 2008.

(51) Int. Cl. B08B 3/12; D06M 10/02

(52) U.S. Cl. 8/137; 68/3 SS

(57) ABSTRACT

Systems and methods in accordance with the invention cause substantially the entire area of a fabric article to be laundered is efficiently and completely exposed to focused ultrasound. In this way, the benefits of cavitation are applied to the article as a whole rather than on a “spot” basis.

### RELATED APPLICATION

The present application claims priority to, and the benefits of, U.S. Ser. No. 61/116,832, filed on Nov. 21, 2008, the entire disclosure of which is hereby incorporated by reference.

### FIELD OF THE INVENTION

The present invention relates to cleaning of fabrics and textile materials, and in particular to ultrasound-based cleaning.

### BACKGROUND

Fabrics and textiles are typically cleaned in washing machines that soak the fabric in generally hot, detergent-laden water with mechanical agitation. In essence, the washing machine applies mechanical energy, thermal energy, and chemical action to the soiled articles. Because chemical cleaning agents can be both expensive and environmentally unfriendly, substantial effort has been directed toward cleaning systems that use no additives—just plain water, which ideally might be reused after the washing cycle, e.g., for agriculture or, with filtration, in subsequent cleaning cycles.

Ultrasound energy offers a viable alternative to traditional detergent-based cleaning approaches, since it is capable of dislodging soils without chemical assistance. Although various deployments of ultrasound in fabric-washing equipment have been attempted, none has attained commercial acceptance. A key limitation of systems thus far proposed is the inability to ensure efficient and complete exposure of the article to adequate levels of ultrasound energy. If the ultrasound is applied with insufficient focus, the energy fluence through the fabric will be inadequate to dislodge soil. On the other hand, highly focused ultrasound may not encounter all portions of a fabric article to be cleaned, or else may require excessive washing times.

### SUMMARY

In accordance with some embodiments of the present invention, substantially the entire area of a fabric article is efficiently and completely exposed to focused ultrasound. As used herein, the term “substantially” means within 10%, and ideally within 5%. In this way, the benefits of cavitation are applied to the article as a whole rather than on a “spot” basis.

Cavitation is a threshold phenomenon triggered by oscillating pressure waves. In the present context, it is caused by the interaction of the acoustic beam with micro-bubbles in the fluid. Cavitation involves two mechanisms: streaming cavitation, in which gas micro-bubbles stream as a result of the acoustic beam generating high shear forces, and inertial cavitation, in which micro-bubbles implode and generate extremely high temperatures and pressures at the micron level. Initiating cavitation requires the existence of micro-bubbles in the fluid. Generating micro-bubbles typically requires a very high cavitation threshold. It is, however, possible to significantly reduce the generation threshold (also called nucleation threshold) for micro-bubbles by actively nucleating the fluid with micro-bubbles. The average diameter of the micro-bubbles desirably is smaller than the resonance radius, which depends on parameters such as the acoustic frequency, fluid parameters, temperature, pressure, etc. The following simplified equation describes the relationship among the resonance radius R₀, the resonance frequency f₀, the ambient pressure P₀, the polytropic exponent of gas κ, and the density ρ of the liquid:

$${f}_{0} = \frac{1}{2 π} \sqrt{\frac{3 κ {P}_{0}}{ρ}} \cdot \frac{1}{{R}_{0}}$$

A typical desired radius is ˜1 μm within a 1 MHz ultrasound field or and 10 μm in a 0.1 MHz ultrasound field.

Streaming and inertial cavitation can be used to clean fabrics. Sheer forces generated by the streaming cavitation and localized high pressures and temperatures generated by the inertial cavitation remove soil without the need for chemical additives (e.g., detergents), although it should be emphasized that systems in accordance herewith may be used with detergents in a manner that reduces their environmental impact—e.g., enabling the use of smaller amounts of traditional detergents, or enhancing the action of more environmentally friendly but less efficacious detergents so they become more acceptable to consumers or reducing the power consumption used to heat the water.

Accordingly, in one aspect, an apparatus for laundering fabric articles in accordance with the invention may include a chamber for receiving fabric articles to be laundered; a source of ultrasound energy focusing to one or more foci, each of which may be, for example, point-shaped or linear, within the chamber; and a handling system for ensuring that substantially the entireties of the fabric articles pass at least once through at least one of the foci during a cleaning cycle. The apparatus may direct an acoustic beam in the form of a pressure wave within the cavity so that it interacts with soiled fabrics in various ways, e.g., via propagation, reflection, absorption, scatter and/or cavitation.

The handling system may include a feeding mechanism (based, for example, in an Archimedes screw) to draw the articles into the chamber. In various embodiments, the apparatus further comprising means for enforcing a standing-wave condition in the cavitation chamber, e.g., by adaptively changing the frequency or phasing, or the water level. Means for introducing micro-bubbles into the cavitation chamber may also be included, so that the fabric articles are exposed to streaming and inertial cavitation.

Various other features may be included. For example, the apparatus may include comprising a sensing module to monitor the extent of cleaning. A controller, responsive to the sensing module, may cause water in the cavitation chamber to be filtered or replaced with a new or recycled volume of water. A sensing module may be employed to monitor cavitation and the controller may responsively alter acoustic power, a temporal transmission regime and/or frequency of the ultrasound energy.

In some embodiments, the cavitation chamber is cylindrical with a first portion containing an acoustic transducer with a line focus extending axially along the center of the chamber and a second portion opposed to the first portion forming a reflector. In other embodiments, the ultrasound energy is focused to multiple foci distributed within the cavitation chamber.

The apparatus may have a separate cleaning chamber, in which case the handling system transfers fabric articles from the cleaning chamber to the cavitation chamber. The cavitation chamber, in turn, may take the form of a drum having, disposed along an inner wall thereof, a series of acoustic-wave emitting plates having axial foci each at different focal depths. In some embodiments, the emitting plates have the same focal depth and a reflector with a different focal depth is set in opposition to each emitting plate.

In another aspect, an apparatus for laundering fabric articles comprises a rotatable chamber for receiving the fabric articles to be laundered, at least a portion of the chamber being substantially transparent to ultrasound energy; at least one stationary ultrasound source, surrounding the rotatable chamber, for directing ultrasound energy to different foci within the chamber; and a controller for rotating the chamber and selectively activating the at least one ultrasound source during the rotation. The apparatus may further comprise a water-handling system for introducing water into and withdrawing water from the rotatable chamber during a cleaning cycle. The controller may, for example, ensure a minimum water level during activation of the ultrasound sources.

In some embodiments, at least a portion of the rotatable chamber is substantially transparent to ultrasound energy. For example, the apparatus may comprise a plurality of circumferentially spaced-apart ultrasound sources, with the rotatable chamber equipped with a plurality of circumferentially spaced-apart windows transparent to ultrasound energy and, between the windows, segments of a material that reflects ultrasound energy. The ultrasound sources may have foci at different focal depths, or the reflective segments may each focus ultrasound to a focus different from that of the other segments.

In still another aspect, the invention relates to an apparatus for laundering fabric articles. The apparatus comprises a chamber for receiving the fabric articles to be laundered; means for directing ultrasound energy into the chamber; a handling system for drawing fabric articles through the chamber; and means for introducing micro-bubbles into the chamber, whereby the fabric articles are exposed to streaming and inertial cavitation. The micro-bubbles have sizes optimized to enhance cavitation.

In yet another aspect, the invention pertains to a method of laundering fabric articles. The method comprises the steps of receiving, in a chamber, the fabric articles to be laundered; directing ultrasound energy to one or more foci within the chamber; and handling the fabrics such that substantially the entire areas of the fabric articles pass at least once through a cavitation region during a cleaning cycle.

Still another aspect of the invention relates to a method of laundering fabric articles that involves receiving, in a chamber, the fabric articles to be laundered so the articles are submerged in a liquid; directing ultrasound energy into the chamber; drawing fabric articles through the chamber; and introducing micro-bubbles into the chamber, whereby the fabric articles are exposed to streaming and inertial cavitation.

In still another aspect of the invention, a method of laundering fabric articles comprises the steps of rotating a chamber in which the fabric articles are submerged in a liquid; and during the rotation, selectively activating a plurality of circumferentially disposed, stationary ultrasound sources around the chamber to direct ultrasound energy to different foci within the chamber.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 schematically illustrates a representative embodiment of the invention;

FIG. 2 schematically illustrates a representative mechanical configuration of a focused-ultrasound washing machine in accordance with the invention;

FIG. 3 is a cross-section through a representative cavitation chamber;

FIG. 4A illustrates a segment of a cylindrical cavitation chamber in accordance with another embodiment of the invention;

FIG. 4B is a cross-section through the embodiment shown in FIG. 4A; and

FIG. 4C is a cross-section through an alternative embodiment in which the transducers remain fixed.

### DETAILED DESCRIPTION

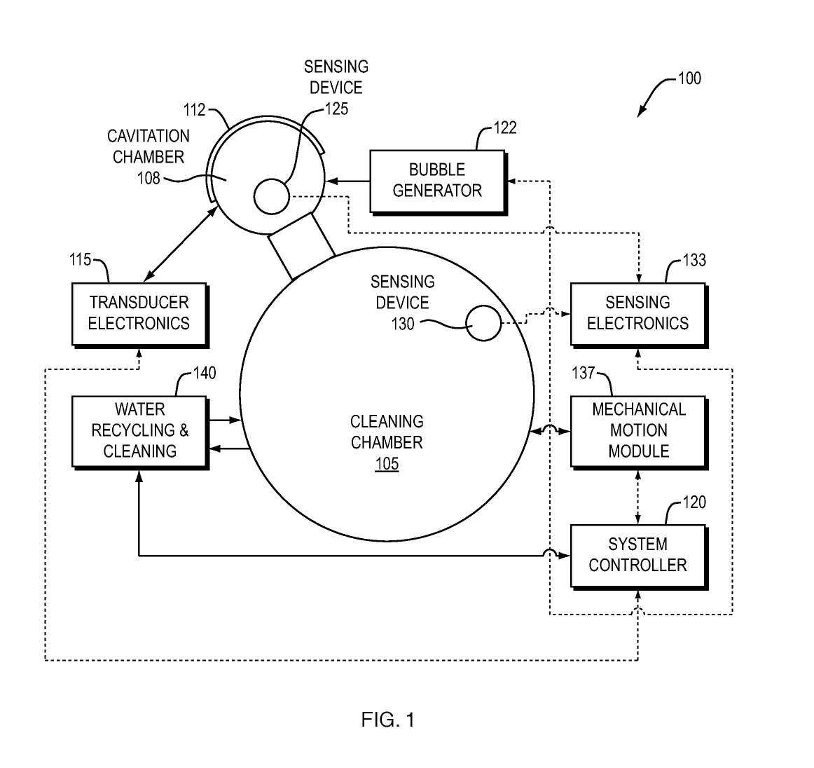

An exemplary system 100 in accordance with the present invention is illustrated in FIG. 1. The system includes a cleaning chamber 105 that receives fabric articles to be cleaned and an amount of water sufficient to immerse the articles. A cavitation chamber 108, which includes an ultrasound transducer 112, is mechanically coupled to the cleaning chamber 105 such that fabric articles may be passed between the chambers 105, 108 by a mechanical handling system (described below). In general, chambers 105, 108 are metal, particularly where ultrasound reflections are produced as discussed below, although it is possible to coat the interior surface with a thin layer of plastic that does not interfere with energy transmission. Cleaning takes place within the cavitation chamber 108. A conventional acoustic driver circuit 115, under the control of a system controller 120, operates the transducer 112.

As further described below, the ultrasound beam is focused within the cavitation volume to trigger cavitation effects, and a source 122 of micro-bubbles, also operated by system controller 120, saturates the fluid in the cavitation chamber with micro-bubbles having sizes (e.g., a radius smaller than the resonance radius) optimized to enhance cavitation. A sensing device 125 monitors the level of cavitation in the in chamber 108, e.g., by means of a conventional acoustic sensor. In some embodiments, sensing device 125 also monitors the cleanliness level of the water and/or the fabrics. For example, the device 125 may measure the clarity of the water to assess whether cleaning has been completed; alternatively, the device may measure the reflectance of the fabrics. In other embodiments, a separate cleaning sensor 130 is disposed within cleaning chamber 105, and operates by measuring water clarity or fabric reflectance (or both).

Sensing device(s) 125, 130 are operated by conventional circuitry 133, which supplies power to the device(s), receives sensor signals, and communicates with system controller 120. In some embodiments, circuitry 133 receives signals (e.g., digital signals) from controller 120 periodically during a cleaning cycle and, in response, obtains readings from device(s) 125, 130. These readings may, for example, be in analog form, in which case circuitry 133 includes an analog-to-digital converter, which outputs a pulse train indicative of the sensed reading to controller 120. Alternatively, the sensor(s) may be operated continuously.

Articles within cleaning chamber 105 may be subjected to mechanical agitation in order to further the cleaning process in the manner of a conventional clothes washer. A central, finned agitation post, for example, may be operated by a mechanical motion module 137 under the control of system controller 120. Water fills cleaning chamber 105 and is drained therefrom by conventional plumbing and valves (not shown). Instead of being drained during a cleaning cycle, however, water in the cleaning chamber 105 may be filtered and recycled back into the chamber 105 by means of a recycling module 140. The recycling module 140 is valved to the drain plumbing and contains one or more particle and/or other filters for removing soils from the water. Modules 137, 140 are operated by system controller 120 over the course of a cleaning cycle, for example, based at least in part on feedback from the sensing device(s) 125, 130.

In operation, fabric articles are loaded into cleaning chamber 105, where system controller 120 causes water to be introduced so as to fully immerse the articles. Controller 120 may thereupon direct mechanical motion module 137 to impart an initial interval of agitation, followed by water filtration and re-introduction by means of the recycling module 140. Articles then pass into the cavitation chamber 108, where they are subjected to focused ultrasound and subsequently discharged back into cleaning chamber 105. During ultrasound treatment, controller 120, via sensing device 125, determines the level of cavitation. Controller 120 changes—or alerts the user to change—the acoustic power, temporal transmission regime and/or frequency of the energy emitted by transducer 112 to achieve the desired cleaning effect. Based on the sensed level of water cleanliness, controller 120 may, for example, cause the water to be filtered or replaced with new volume of water via recycling module 140, and/or cause the fabrics to undergo another sonication in chamber 108, and/or adjust the operation of transducer 112. Finally, controller 120 causes the fabric articles in chamber 105 to undergo a conventional drain/wash/rinse cycle.

More generally, of course, it is possible to use “open-loop” approaches that do not involve feedback, based, for example, on a timer governing the stages of a cleaning cycle in terms of fixed intervals, or on visual inspection.

FIG. 2 illustrates a representative implementation of chamber 108 and its disposition within chamber 105. The chamber 108 takes the form of a cylindrical pipe with a flared receiving end 150. The transducer 112 (see FIG. 1) extends over a cleaning zone Z having a volume of, for example, 10 to 60 liters. A conical Archimedes screw 155 captures soiled fabrics within chamber 105 and feeds them into the cavitation chamber 108. The rate at which the fabrics are fed is determined by controller 120 and depends on the level of cleaning required: for light cleaning the feed rate will be fast, while for dirty fabrics the feed rate will be low. For example, the rate may be set by controller 120 based on an initial reflectance reading from sensing device 130. Archimedes screw 155 forces articles through the length of chamber 108 as it receives new articles from chamber 105, and finally forces the last articles through chamber 108 by simple conveyance of water.

In the illustrated embodiment, chamber 108 is canted with respect to chamber 105 to facilitate the flow of fabrics therethrough while keeping them below the water line. Chamber 108 may be incorporated within a central agitation post for compactness of construction.

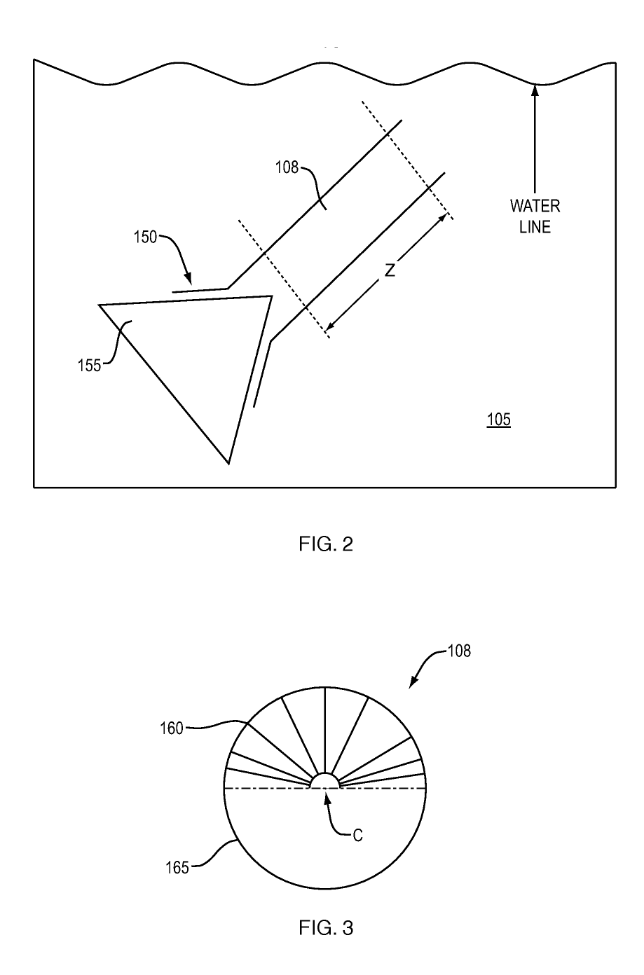

A representative cavitation chamber 108, shown sectionally in FIG. 3, takes the form of a short (e.g., 20 to 60 cm) cylindrical pipe divided into two portions: the upper half-cylinder portion 160 comprises an acoustic transducer with a line focus extending axially along the center of the pipe, while the lower half-cylinder portion is metallic and acts as refocusing reflector. For example, the interior surface of half-cylinder 160 may be the output surface of transducer 112 (see FIG. 1) which, as shown in FIG. 3, emits ultrasound toward the center C (so that along the length of the transducer 112, ultrasound is focused along the central axial line extending through cylinder 108).

Bubble-generation module 122 (see FIG. 1) may be used to nucleate the cavitation volume with micro-bubbles. Exposure of the fabric surface area to the ultrasound focus or, more preferably, foci is achieved by utilizing a chamber having a size and shape optimized to generate cavitation throughout its volume (or at least a large fraction of the volume). In FIG. 3, the single line focus means that fabrics must be agitated for a sufficient time and with adequate movement in the chamber to ensure that all points pass through the linear focus. Alternatively, the reflector segment 165 may be shaped by deviating from the cylindrical surface or by tilting the cylindrical surface to create multiple focal lines through the chamber; the greater the number of ultrasound foci, the less time and agitation will be needed to ensure complete exposure of the fabric to cavitation. Alternatively or in addition, the upper half-cylinder 160 (i.e., the transducer) may be designed with multiple foci by deviating from cylindrical surface or by building it as a phased array capable of steering the beam and the focus elctronically.

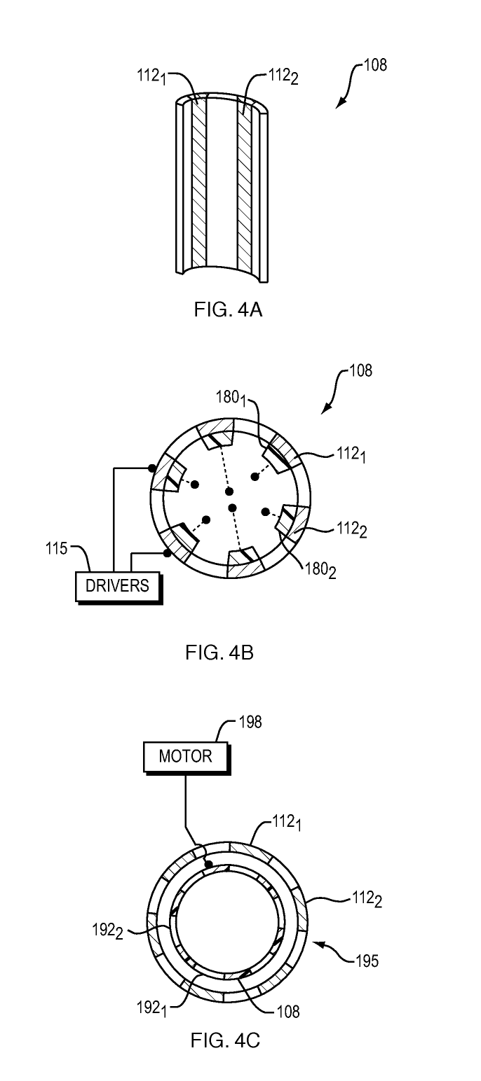

In still another implementation, illustrated in FIGS. 4A and 4B, sonication occurs within the cleaning chamber 108. One or more cylindrical sectors of the interior drum wall contain or are configured as acoustic-wave emitting plates, two of which are representatively indicated at 112₁, 112₂. For example, each plate 112ₙ may extend over the entire cylindrical height of the chamber 108 as illustrated, or instead, circumferentially adjacent plates may extend over partial but overlapping (or adjacent) portions of the cylindrical height. The plates have different axial foci, each at a different focal depth, as shown in FIG. 4B. This can be accomplished, for example, by pre-shaping the transmitting surface to focus at a point or a line or by using lenses 180 associated with each of the plates 112₁ . . . 112ₙ. The lenses 180 may be, for example, plastic or other suitable material.

Alternatively, on the opposite side of the drum from each emitting plate, a reflector with a different focal depth may be disposed. In still another alternative, the semicylindrical transducer 112 shown in FIG. 1 may be employed as a stationary fixture around half of the rotating chamber 108. These arrangements can accommodate top-loading or side-loading configurations.

To avoid the need to power rotating arrays, the drum 108 can be made from an acoustically transparent material (e.g., MYLAR) or include windows 192₁ . . . 192ₙ, (collectively 192) of such material as shown in FIG. 4C. The transducers 112₁ . . . 112ₙ, (collectively 112) are arranged around a stationary fixture 195 that surrounds the drum 108. In this way, operation of the stationary transducer segments 112 is synchronized to the rotation and orientation of the drum 108 by a conventional motor 198, such that the segments 112 are active only when facing an acoustic window 192 of the rotating drum. Because motor 198 is operated by controller 198, the controller can readily track the instantaneous angular positions of the windows 192. Once again, the transducer segments 112 may have different foci or, instead, the unwindowed portions of drum 108, which act as reflectors for ultrasound passing through opposed windows 192, can be focused along different interior line foci.

In a representative implementation, the invention takes the form of a traditional front-loading washing machine having a static, horizontally oriented drum of radius R in which the transducer segments are mounted and, concentrically within the static drum, a smaller-diameter rotating drum for containing fabric articles to be cleaned. The interior drum has a depth L and, after loading with soiled fabric articles, the interior drum is filled with water to a height of R/2. The rotating drum has N acoustically transparent windows around its circumference (between N+1 ribs or reflective segments). But the transducer segments are disposed only around the lower semicylindrical half of the static drum.

In particular, the lower half of the external static drum surface has M<N/2 transducer segments of size L×W, each of which can be switched on independently of one another. Each of these segments has a preset focal area within the rotating interior drum. The transducer width W<2π/N, and each transducer segment is pre-focused at a predefined distance D<R/2. Preferably, one or more standing waves is induced and maintained during operation; this minimizes the input energy necessary to sustain the cleaning process. A standing wave can be created and maintained by adaptively changing the frequency or phasing, or the water level. In the representative implementation, roughly up to ⅓ of the drum surface radiates at any given time, and a given transducer segment is active for roughly ⅓ of a full rotation. Assuming a drum speed of 60 RPM, the duty cycle is 33% at most, with a burst pulse repetition rate of 1 sec. Controller 120 monitors the water level and causes water to be added as necessary, disabling the transducer segments if the water level becomes insufficient, and may also control the frequency and/or phasing to enforce a standing-wave condition.

In operation, the interior drum is rotated at a normal speed in both directions in order to cause the fabric articles to mix and change relative location within the drum. As the drum rotates, controller 120 monitors the instanteous angular position of the drum relative to the fixed transducers, and as a window begins to pass in front of a transducer segment, controller 120 activates that segment via an associated driver 115, causing the transducer to emit an energy burst that sustains cavitation in the water above it. Controller 120 deactivates the segment when the window rotates out of alignment therewith. In general, the transducer segments are distributed symmetrically around the circumference of and, as a result, will be simultaneously active or inactive. Controller 120 integrates sonication cycles within the overall cleaning cycle for maximum effectiveness, subsequently initiating a standard drain/wash/spin cycle.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. Apparatus for laundering fabric articles, the apparatus comprising:
a cavitation chamber for receiving the fabric articles to be laundered;
a source of ultrasound energy focusing to one or more foci within the cavitation chamber; and
a handling system for ensuring that substantially the entireties of the fabric articles pass at least once through a cavitation region during a cleaning cycle.

2. The apparatus of claim 1 wherein the handling system includes a feeding mechanism to draw the articles into the chamber.

3. The apparatus of claim 2 wherein the feeding mechanism comprises an Archimedes screw.

4. The apparatus of claim 1 further comprising means for enforcing a standing-wave condition in the cavitation chamber.

5. The apparatus of claim 1 further comprising means for introducing micro-bubbles into the cavitation chamber, whereby the fabric articles are exposed to streaming and inertial cavitation.

6. The apparatus of claim 1 further comprising a sensing module to monitor the extent of cleaning and a controller, responsive to the sensing module, for causing water in the cavitation chamber to be filtered or replaced with a new or recycled volume of water.

7. The apparatus of claim 1 further comprising a sensing module to monitor cavitation and a controller, responsive to the sensing module, for responsively altering at least one of acoustic power, a temporal transmission regime or frequency of the ultrasound energy.

8. The apparatus of claim 1 wherein the cavitation chamber is cylindrical with a first portion containing an acoustic transducer with a line focus extending axially along the center of the chamber and a second portion opposed to the first portion forming a reflector.

9. The apparatus of claim 1 where the ultrasound energy is focused to multiple foci distributed within the cavitation chamber.

10. The apparatus of claim 1 further comprising a separate cleaning chamber, the handling system transferring fabric articles from the cleaning chamber to the cavitation chamber.

11. The apparatus of claim 1 wherein the cavitation chamber is in the form of a drum having, disposed along an inner wall thereof, a series of acoustic-wave emitting plates having axial foci each at different focal depths.

12. The apparatus of claim 11 wherein the emitting plates have the same focal depth and further comprising, opposed to each emitting plate, a reflector with a different focal depth.

13. Apparatus for laundering fabric articles, the apparatus comprising:
a rotatable chamber for receiving the fabric articles to be laundered, at least a portion of the chamber being substantially transparent to ultrasound energy;
surrounding the rotatable chamber, at least one stationary ultrasound source for directing ultrasound energy to different foci within the chamber; and
a controller for rotating the chamber and selectively activating the at least one ultrasound source during the rotation.

14. The apparatus of claim 12 further comprising a water-handling system for introducing water into and withdrawing water from the rotatable chamber during a cleaning cycle.

15. The apparatus of claim 13 wherein the controller ensures a minimum water level during activation of the ultrasound sources.

16. The apparatus of claim 13 wherein at least a portion of the rotatable chamber is substantially transparent to ultrasound energy.

17. The apparatus of claim 13 comprising a plurality of circumferentially spaced-apart ultrasound sources, wherein the rotatable chamber has a plurality of circumferentially spaced-apart windows transparent to ultrasound energy and, between the windows, segments of a material that reflects ultrasound energy.

18. The apparatus of claim 11 wherein the ultrasound sources have foci at different focal depths.

19. The apparatus of claim 15 wherein the ultrasound sources have a consistent focal depth and the reflecting segments each have a different focal depth.

20. Apparatus for laundering fabric articles, the apparatus comprising:
a chamber for receiving the fabric articles to be laundered;
means for directing ultrasound energy into the chamber;
a handling system for drawing fabric articles through the chamber; and
means for introducing micro-bubbles into the chamber, whereby the fabric articles are exposed to streaming and inertial cavitation, the micro-bubbles having sizes optimized to enhance cavitation.

21. A method of laundering fabric articles, the method comprising the steps of:
receiving, in a chamber, the fabric articles to be laundered;
directing ultrasound energy to one or more foci within the chamber; and
handling the fabrics such that substantially the entire areas of the fabric articles pass at least once through a cavitation region during a cleaning cycle.

22. A method of laundering fabric articles, the method comprising the steps of:
receiving, in a chamber, the fabric articles to be laundered so the articles are submerged in a liquid;
directing ultrasound energy into the chamber;
drawing fabric articles through the chamber; and
introducing micro-bubbles into the chamber, whereby the fabric articles are exposed to streaming and inertial cavitation.

23. A method of laundering fabric articles, the method comprising the steps of:
rotating a chamber in which the fabric articles are submerged in a liquid; and
during the rotation, selectively activating a plurality of circumferentially disposed, stationary ultrasound sources around the chamber to direct ultrasound energy to different foci within the chamber.
